(19) United States
(12) Patent Application Publication
(10) Pub. No.: US 2020/0311753 A1
(43) Pub. Date: Oct. 1, 2020

(54) REINFORCEMENT LEARNING FOR CUSTOMER CAMPAIGN PREDICTIVE MODELS

(71) Applicant: Capital One Services, LLC, McLean, VA (US)

(72) Inventors: Mark Louis Watson, Urbana, IL (US); Austin Grant Walters, Savoy, IL (US); Fardin Abdi Taghi Abad, Champaign, IL (US); Jeremy Edward Goodsitt, Champaign, IL (US); Reza Farivar, Champaign, IL (US); Anh Truong, Champaign, IL (US); Kenneth Taylor, Champaign, IL (US); Vincent Pham, Champaign, IL (US)

(73) Assignee: Capital One Services, LLC, McLean, VA (US)

(21) Appl. No.: 16/365,646

(22) Filed: Mar. 26, 2019

(51) Int. Cl. G06Q 30/02

(52) U.S. Cl. CPC G06Q 30/0211; G06Q 30/0224; G06Q 30/0239; G06Q 30/0201

(57) ABSTRACT

The present disclosure provides computing systems and techniques for evaluating effectiveness of models used to generate product offers. A server can generate a product offer from one of a number of customer engagement models. The server can determine an effectiveness of each of the models based on user interactions with the precut offers. The determined effectiveness can be used to specify a dominant or baseline model to be used in a majority of instances.

### TECHNICAL FIELD

Examples described herein are generally related to sales campaign engagement and particularly to evaluating models used to predict customer engagement with sales campaigns.

### BACKGROUND

Many companies present offers (e.g., advertisements) to visitors of their website. Some companies select the offer to present from a pool of available offers based on information about the visitor. For example, some companies may select the offer based on an algorithm that attempts to predict a likelihood that the customer will act on the offer. Evaluation of these algorithms and the techniques used to select or predict customer engagement is difficult. The present disclosure is directed towards evaluating techniques used to select offers to present to customers.

### BRIEF DESCRIPTION OF THE DRAWINGS

FIG. 1 illustrates an example computing device.

FIG. 2 illustrates a first example system.

FIG. 3 illustrates portions of the first example system of FIG. 2 in greater detail.

FIG. 4 illustrates an example technique to evaluate customer engagement models.

FIG. 5 illustrates a first example logic flow to generate a product offer.

FIG. 6 illustrates a second example logic flow for adding or removing customer engagement models.

FIG. 7 illustrates an example storage medium.

FIG. 8 illustrates an example computer architecture.

### DETAILED DESCRIPTION

The present disclosure provides for the evaluation and comparison of techniques used to select offers to present to customers. Said differently, embodiments of the present disclosure can be implemented to evaluate multiple techniques used to select offers to present to customers. The techniques can be deployed concurrently and evaluation of the rates of customer engagement respective to each technique can be compared, for example, in a real time basis. The technique with the highest customer engagement can be designated as a primary technique and used in a majority of cases to select offers to present, while alternative techniques can continue to be concurrently used in a smaller percentage of cases and their performance evaluated against the performance of the primary technique.

For example, a customer engagement model can be used to select an offer to present to a user based on a prediction of the user's likelihood to act on the offer. The effectiveness of the model can be determined based on, for example, customer “click through” or subsequent purchase data. Multiple different models could be used concurrently. For example, multiple new or development models could be used on a limited basis while a baseline model is used on a more regular basis. The effectiveness of the development models could be compared to the effectiveness of a baseline model and the baseline model could be replaced or updated based on a development model having better effectiveness.

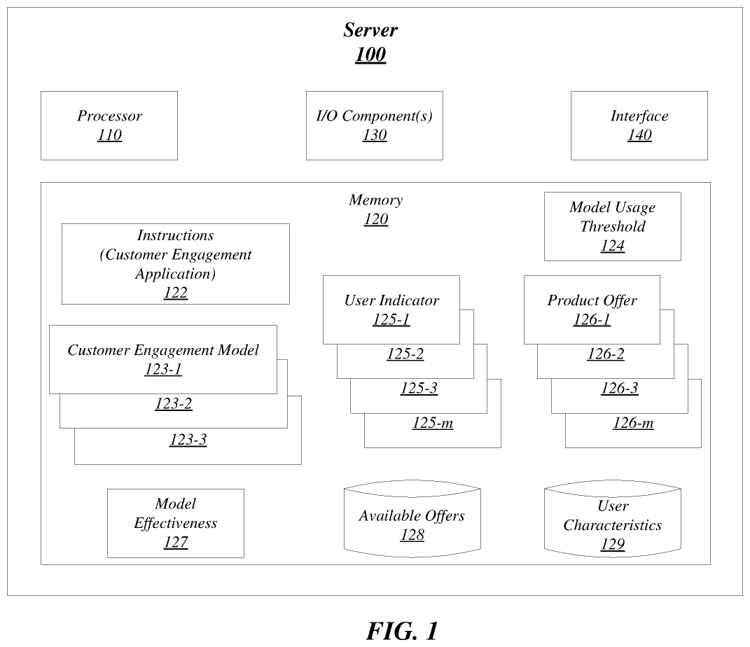

FIG. 1 illustrates an example server 100. The server 100 could be incorporated into a company's backend website services, mobile application services, or the like. For example, server 100 could be coupled to computing resources (e.g., servers, cloud hosted computing services, etc.) arranged to host websites. As another example, server 100 could be coupled to computing resources (e.g., servers, cloud hosted computing services, etc.) arranged to service a mobile application. In general, server 100 operates to select a product offer to present (e.g., on the website, via the mobile application, or the like) to a user and to evaluate different models used to select the offer to present.

The server 100 can include, at least in part, a processor 110, a memory 120, input/output (I/O) component(s) 130, and interface 140. Memory 120 may store instructions 122, which are executable by processor 110. Instructions 122 can correspond to a customer engagement application. Memory 120 may further store customer engagement models 123-n, where n is a positive integer, often greater than 1. This figure depicts memory 120 storing customer engagement model 123-1, 123-2 and 123-3. It is noted however, that the number of customer engagement models 123 stored by memory 120 and used as described herein can be any number. This figure depicts three (3) customer engagement models 123 for purposes of clarity only, and not to be limiting. Memory 120 may further store model usage threshold 124, user indicator 125, product offers 126, model effectiveness 127, available offers database 128, and user characteristic database 129.

In general, customer engagement models 123-n can any of a variety of types of predictive models used to select, or predict, a product offer from the available offers database 128 that will have the greatest chance of success or bring the highest return given characteristics about the user with which the product offer is to be presented. In some examples, customer engagement models 123-n can a connected network predictor, such as, for example, a neural network. Examples are not limited in this context.

In general, responsive to executing instructions 122, server 100 can receive a request to generate product offers 126-m. In some examples, the request can include an indication of a user indicator 125-m. Server 100 can receive user indicator 125-m for multiple users (e.g., mobile application users, website visitors, or the like) corresponding to users with which product offers 126-m are to be generated and presented. Server 100, in executing instructions 122, can generate product offers 126-m based in part on one of the customer engagement models 123-n. Given a user indicator 125, the customer engagement models 123-n can select an offer from the available offers database 128 based on the user indicator 125 and the user characteristics database 129; and can output the selected offer as product offer 126. In general, the customer engagement models 123-n generate product offer 126 based on predicting which offer from the available offers database 128 the respective user is most likely to engage with (e.g., ultimately accept the offer, or the like).

With some examples, user indicator 125-m can include a unique identifier used to identify a particular user from a group of users; or used to identify characteristics about the user. For example, user indicator 125-m can include an indication of a username, login credentials, physical address, telephone number, media access control (MAC) address, Internet browser identifier(s), or the like. In some embodiments, user characteristics database 129 can include indications of characteristics about multiple individual users, which can be referenced by user indicator 125-m. For example, user characteristics database 129 can include indications of demographic data, family data, income data, employment data, liquid asset data, credit history data, investment history data, purchase history data, prior customer engagement data, or the like.

Server 100, in executing instructions 122, can determine which customer engagement model 123-n to use to generate the product offer 126 based on model usage threshold 124. Model usage threshold 124 can specify how often each customer engagement model 123-n should be used respective to the other customer engagement models 123-n. For example, one of the customer engagement models 123-n (assume customer engagement model 123-1) can be designated as a baseline model while the other customer engagement models (assume customer engagement models 123-2 and 123-3) can be designated as development or trial models. Model usage threshold 124 may include an indication of a usage ratio for the baseline model and the development models. As a specific example, model usage threshold 124 can indicate that the baseline model (e.g., customer engagement model 123-1) is to be used 96 percent of the time while each of the baseline models (e.g., customer engagement models 123-2 and 123-3) are to be used 2 percent of the time. The usage ratio indicated by model usage threshold 124 can be dependent upon the particular implementation and may vary depending on the number of development models used. In some examples, model usage threshold 124 can indicate that the baseline model is to be used greater than 90% of the time while the total usage for all the development models is to be 10% of the overall usage. As another example, model usage threshold 124 can indicate that the baseline model is to be used 99% of the time while the total usage for all the development models is to be 1% of the overall usage.

Server 100, in executing instructions 122, can determine model effectiveness 127 for each of the customer engagement models 123-n. More specifically, server 100, in executing instructions 122, can whether the user engaged with (e.g., clicked through to a detailed product offering, accepted the offer, requested additional information about the offer, etc.) the product offer 126. With some examples, model effectiveness 127 can include, for each of the customer engagement models 123-n, an indication of the percentage of generated product offers that the customer engaged with.

With some examples, the processor 110 may include circuity or processor logic, such as, for example, any of a variety of commercial processors. In some examples, the processor 110 may include multiple processors, a multi-threaded processor, a multi-core processor (whether the multiple cores coexist on the same or separate dies), and/or a multi-processor architecture of some other variety by which multiple physically separate processors are in some way linked. Additionally, in some examples, the processor 110 may include graphics processing portions and may include dedicated memory, multiple-threaded processing and/or some other parallel processing capability.

The memory 120 may include logic, a portion of which includes arrays of integrated circuits, forming non-volatile memory to persistently store data or a combination of non-volatile memory and volatile memory. It is to be appreciated, that the memory 120 may be based on any of a variety of technologies. In particular, the arrays of integrated circuits included in memory 120 may be arranged to form one or more types of memory, such as, for example, dynamic random access memory (DRAM), NAND memory, NOR memory, or the like.

The I/O component(s) 130 may include one or more components to provide input to or to provide output from the server 100. For example, the I/O component(s) 130 may be a keyboard (hardware, virtual, etc.), mouse, joystick, microphone, track pad, button, touch layers of a display, haptic feedback device, camera, microphone, speaker, or the like.

Interface 140 may include logic and/or features to support a communication interface. For example, the interface 140 may include one or more interfaces that operate according to various communication protocols or standards to communicate over direct or network communication links. Direct communications may occur via use of communication protocols or standards described in one or more industry standards (including progenies and variants). For example, the interface 140 may facilitate communication over a bus, such as, for example, peripheral component interconnect express (PCIe), non-volatile memory express (NVMe), universal serial bus (USB), system management bus (SMBus), SAS (e.g., serial attached small computer system interface (SCSI)) interfaces, serial AT attachment (SATA) interfaces, or the like.

During operation of computing device 100, processor 110 can execute the customer engagement application (e.g., instructions 122) to generate product offers for any of a variety of services. As a specific example, server 100 could be coupled to a website or mobile banking application of a banking institution and arranged to generate product offers for presentation to website visitors or mobile application users. In such an example, the available offers database 128 could include credit card offers, installment loan offers, deposit account offers, investment account offers, or the like. As another example, server 100 could be coupled to a website or mobile application of an automobile manufacture and arranged to generate product offers for presentation to website visitors. In such an example, the available offers database 128 could include new vehicle discounts, lease discounts, maintenance/service coupons, manufacturer financing offers, or the like.

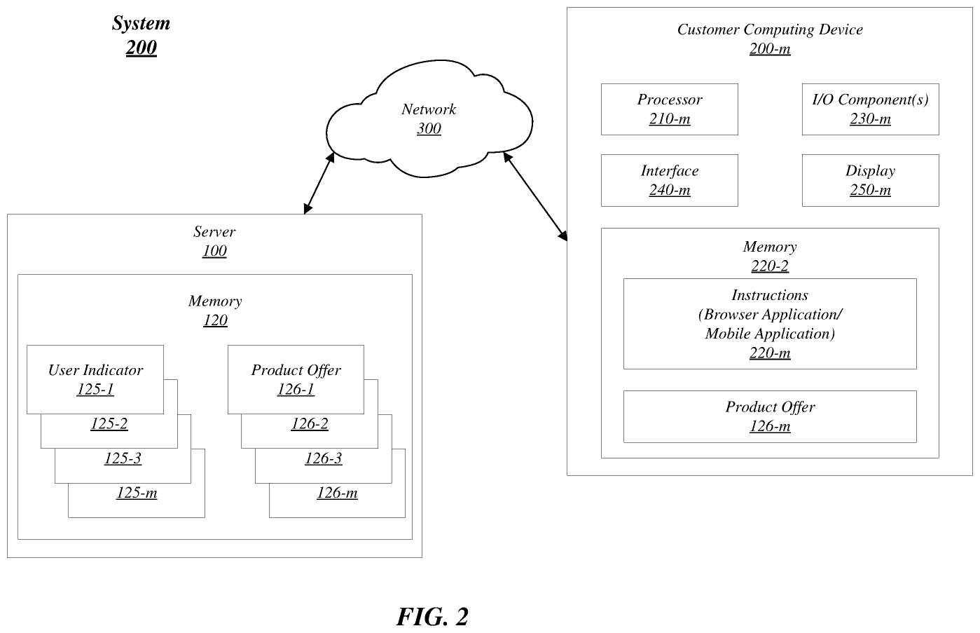

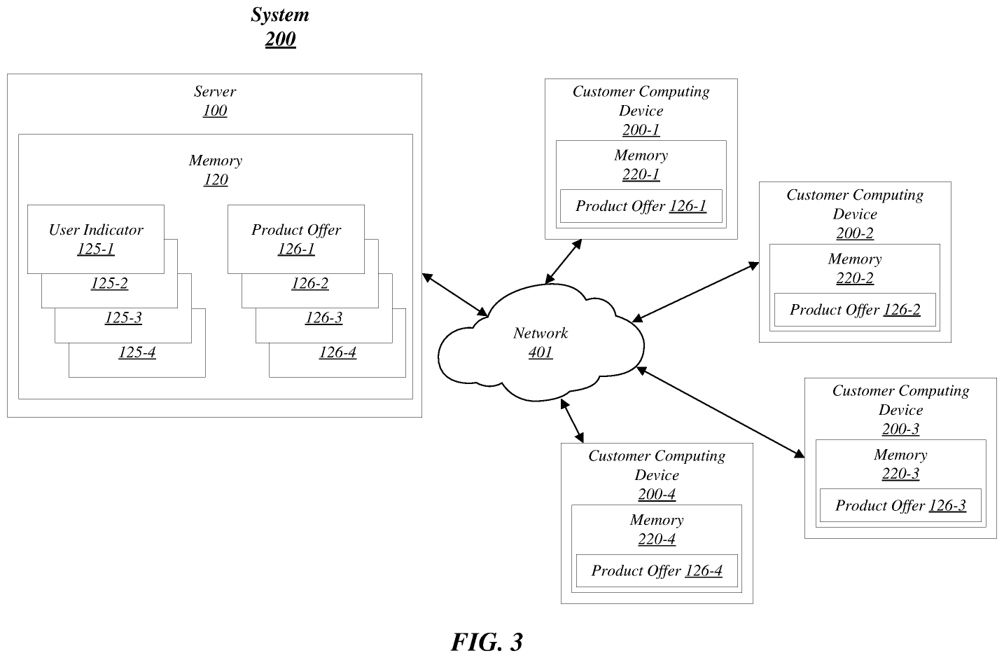

FIGS. 2 and 3 illustrates an example system 200 including customer computing devices 200-m coupled to server 100 of FIG. 1 via a network 300, where m is a positive integer. Network 300 could be, for example, a local area network (LAN), a wide area network (WAN), or a cellular network (e.g., LTE, 3GPP, or the like). In some embodiments, network 300 could include the Internet. System 200 is depicted including customer computing devices 200-1, 200-2, 200-3, and 200-4. It is noted that the number of customer computing devices is given for purposes of clarity of presentation only and not to be limiting. Embodiments can be provided with more of less customer computing devices than depicted in this figure. In practice, a large number (e.g., thousands, hundreds of thousands, etc.) customer computing devices 200-m may be coupled to server 100 via network 300.

FIG. 2 depicts one of customer computing devices 200-m in greater detail while FIG. 3 depicts portions of customer computing devices 200-1 to 200-4. FIGS. 2 and 3 are described and referenced together for convenience. Customer computing devices 200-m can include, at least in part, a processor 210-m, a memory 220-m, I/O component 230-m, an interface 240-m, and a display 250-m. Memory 220-m may store instructions 222-m, which are executable by processor 210-m. Instructions 222-m can correspond to a web browser application used to access a website associated with server 100 or a mobile application used to access a mobile application associated with server 100. Memory 220-m can further store product offer 126-m.

During operation, customer computing devices 200-m can connect to server 100 to access services, such as a website or mobile application, associated with or provided by server 100. Server 100 can receive (e.g., from customer computing device 200-m) or determine from customer computing device 200-m user indication 125-m. User indication 125-m can be any indication used to identify a user. For example, user indication 125-m can include an indication of interface 230-m, login credentials with which customer computing device 200-m logs into a website or mobile application, or the like. Server 100 can generate product offer 126-m for customer computing device 200-m based on one of customer engagement models 124-n as described herein. The product offer 126-m can be communicated to customer computing device 200-m for presentation by a user. For example, customer computing device 200-m can present the product offer 126-m as part of a webpage displayed on display 250-m or as part of a mobile application user interface (UI) displayed on display 250-m.

Turning more specifically to FIG. 3, server 100 can determine user indicators 125-m for each of customer computing devices 200-m coupled to server 100 via network 300. For example, memory 120 is depicted storing user indicators 125-1 to 125-4 corresponding to customer computing devices 200-1 to 200-4, respectively. Server 100 can generate product offers 126-m for each of the customer computing devices 200-m. As described above, product offers 126-m can be generated by one of customer engagement models 123-n. The customer engagement models 123-n can be used to select the product offer 126-m from available offers database 128 based on the user indicator 125-m and user characteristics database 129.

The particular customer engagement model 122-n used to select the product offer 126-m depends on the model usage threshold 125. For example, as detailed above, one of the customer engagement models 122-n may be a baseline model and used more frequently than the other customer engagement models 122-n. Server 100 can determine model effectiveness 127 for each of the customer engagement models 122-n based on a response of customer computing device 200-m to the product offer 126-m. The baseline model can be adjusted or updated. Additionally, development models can be added or subtracted based on the model effectiveness 127.

With some examples, the processor 210-m may include circuity or processor logic, such as, for example, any of a variety of commercial processors. In some examples, the processor 210-m may include multiple processors, a multi-threaded processor, a multi-core processor (whether the multiple cores coexist on the same or separate dies), and/or a multi-processor architecture of some other variety by which multiple physically separate processors are in some way linked. Additionally, in some examples, the processor 210-m may include graphics processing portions and may include dedicated memory, multiple-threaded processing and/or some other parallel processing capability.

The memory 220-m may include logic, a portion of which includes arrays of integrated circuits, forming non-volatile memory to persistently store data or a combination of non-volatile memory and volatile memory. It is to be appreciated, that the memory 220-m may be based on any of a variety of technologies. In particular, the arrays of integrated circuits included in memory 221 may be arranged to form one or more types of memory, such as, for example, dynamic random access memory (DRAM), NAND memory, NOR memory, or the like.

The I/O component(s) 230-m may include one or more components to provide input to or to provide output from the customer computing device 200-m. For example, the I/O component(s) 230-m may be a keyboard (hardware, virtual, etc.), mouse, joystick, microphone, track pad, button, touch layers of a display, haptic feedback device, camera, microphone, speaker, or the like.

Interface 240-m may include logic and/or features to support a communication interface. For example, the interface 240-m may include one or more interfaces that operate according to various communication protocols or standards to communicate over direct or network communication links. Direct communications may occur via use of communication protocols or standards described in one or more industry standards (including progenies and variants). For example, the interface 240-m may facilitate communication over a bus, such as, for example, peripheral component interconnect express (PCIe), non-volatile memory express (NVMe), universal serial bus (USB), system management bus (SMBus), SAS (e.g., serial attached small computer system interface (SCSI)) interfaces, serial AT attachment (SATA) interfaces, or the like.

Display 250-m can be based on any of a variety of display technologies, such as, for example, a cathode ray tube (CRT), a liquid crystal display (LCD), plasma display, light emitting diode (LED) display, or an organic light emitting diode (OLED) display. With some examples, display 250-m can be a touch sensitive display. It is noted, display 250-m may be external to the customer computing device 200-m, such as, for example, embodied as a computer monitor or television and coupled to the customer computing device 200-m via any of a variety of display data interfaces.

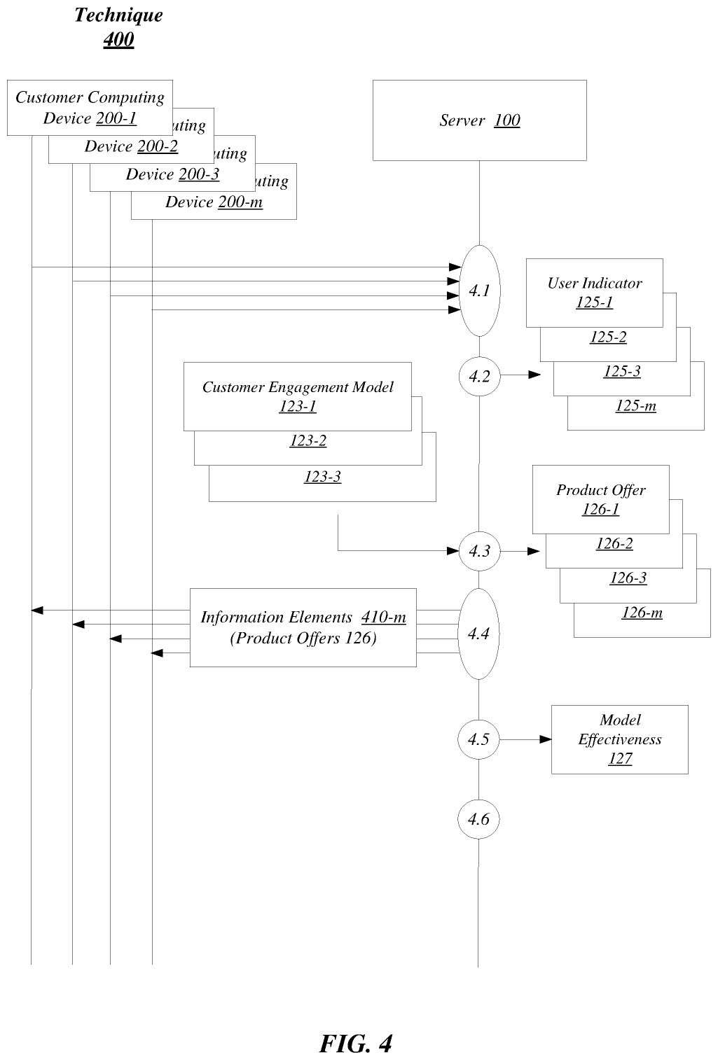

FIG. 4 illustrates a technique 400 to evaluate customer engagement models, according to embodiments of the present disclosure. Technique 400 is described with reference to the system 200 depicted in FIGS. 2 and 3. However, technique 400 could be implemented by a system having a different configuration than depicted. Examples are not limited in this context. Technique 400 can begin at circle 4.1. At circle 4.1, server 100 can receive connections from a number of customer computing devices 200-m. For example, customer computing device 200-1, customer computing device 200-2, customer computing device 200-3, and/or customer computing device 200-m can connect to server 100 as part of accessing a website associated with server 100, as part of executing a mobile application associated with server 100, or the like.

Continuing to circle 4.2, server 100 can determine user indicators 125-m for each of the customer computing devices 200-m connecting to server at circle 4.1. For example, server 100 can determine user indicator 125-1, user indicator 125-2, user indicator 125-3 and user indicator 125-m corresponding to customer computing devices 200-1 to 200-m, respectively. Continuing to circle 4.3, server 100 can generate product offers 126-m for each of the customer computing devices 200-m connecting to server at circle 4.1. As noted above, product offers 126 are generated based in part on one of a number of customer engagement models 123-n. Which customer engagement model 123-n is used depends upon the model usage threshold 124. For example, one of the customer engagement models 123-n may be a baseline model and may be used more frequently than the other ones of the customer engagement models 123-n (e.g., development models, or the like).

Server 100 can determine a product offer 126-m for customer computing device 200-m from one of customer engagement models 123-n, user indicator 125-m, available offers database 128 and user characteristics database 129. Said differently, customer engagement model 123-n can be used to select one of product offers from available offers database 128 to present to customer computing device 200-m. Server 100 can determine product offer 126-1, product offer 126-2, product offer 126-3 and product offer 126-m for customer computing devices 200-1 to 200-m, respectively as detailed herein at circle 4.3.

Continuing to circle 4.4, server 100 can communicate product offers 126-m to respective customer computing devices 200-m. For example, server 100 can send information elements 410-m to respective customer computing devices 200-m. Each information element 410-m can include indications of the product offer 126-m for the respective customer computing device 200-m.

Continuing to circle 4.5, server 100 can determine model effectiveness 127. For example, server 100 can determine, for each customer engagement model 123-n, an effectiveness of the model. Said differently, server 100 can determine an effectiveness (e.g., success rate, customer engagement rate, or the like) for each customer engagement model 123-n based on the product offers 126-m generated by each respective customer engagement model 123-n and whether customer computing devices 200-m interacted with (e.g., clicked through to, requested more information, or the like) the product offers 126-m.

Continuing to circle 4.6, server 100 can adjust the model usage threshold 124, add or remove customer engagement models 123-n, or change which one of the customer engagement model 123-n is the baseline model. For example, if one of the customer engagement models 123-n has a higher model effectiveness 127 than the customer engagement model 123-n designated as the baseline mode, then the customer engagement models 123-n with the higher model effectiveness 127 can be designated as the new baseline model.

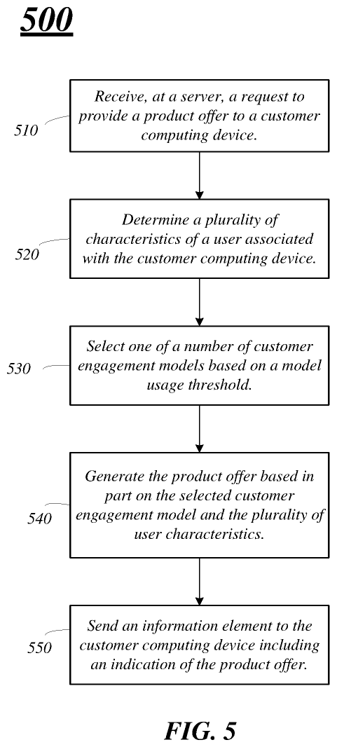

FIG. 5 illustrates a logic flow 500 to generate product offers. A server executing a customer engagement application can generate product offers using logic flow 500. For example, server 100 of FIG. 1 can generate product offers 126-m using logic flow 500. In some implementations, server 100 can use logic flow 500 to generate product offers 126-m as part of technique 400.

Logic flow 500 may begin at block 510. At block 510 “receive, at a server, a request to provide a product offer to a customer computing device” server 100 can receive a request to provide a product offering to a customer computing device. For example, processor 110 in executing instructions 122 can receiving a request to provide product offers 126-m to customer computing devices 200-m. With some implementations, processor 110 in executing instructions 122 can receive a connection from customer computing device 200-m, for example, via interface 130 and network 300, or the like.

Continuing to block 520 “determine a plurality of characteristics of a user associated with the customer computing device 200-m” server 100 can determine user indicator 125-m and characteristics about a user of computing device 200-m based on the determined user indicator 125-m and the user characteristics database 129. Continuing to block 530 “select one of a number of customer engagement models based on a model usage threshold” server 100 can select one of customer engagement models 123-n based on model usage threshold 124. For example, processor 110 in executing instructions 122 can select one of customer engagement models 123-n (e.g., to use at blocks 540) based on model usage threshold 124.

Continuing to block 540 “generate the product offer based in part on the selected customer engagement model and the plurality of user characteristics” server 100 can generate precut offer 126-m from the customer engagement model 123-n selected at block 530, the plurality of characteristics determined at block 520, and available product offering database 128.

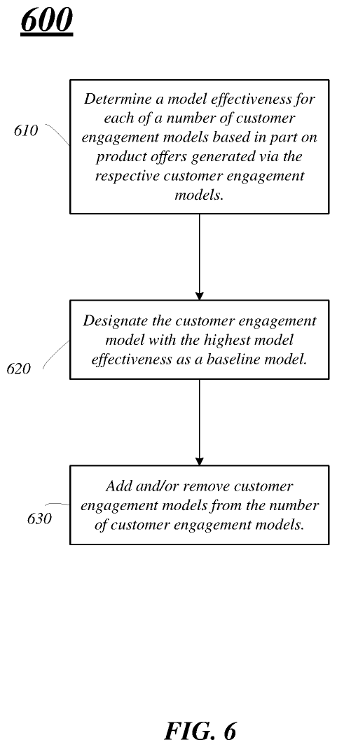

FIG. 6 illustrates a logic flow 600 to evaluate customer engagement models. A server executing a customer engagement application can evaluate customer engagement models using logic flow 600. For example, server 100 of FIG. 1 can evaluate customer engagement models 123-n using flow 600. In some implementations, server 100 can use logic flow 600 to evaluate customer engagement models 123-n as part of technique 400.

Logic flow 600 may begin at block 610. At block 610 “determine a model effectiveness for each of a number of customer engagement models based in part of product offers generated via the respective customer engagement models” server 100 can determine effectiveness for each of a number of customer engagement models based in part of product offers generated via respective customer engagement models. For example, processor 110 in executing instructions 122 can determine model effectiveness 127 for customer engagement models 123-n. In some implementations, processor 110 in executing instructions 122 can determine model effectiveness 127 based on customer interactions with product offers 126-m generated by respective customer engagement models 123-n.

Continuing to block 620 “designate the customer engagement model with the higher model effectiveness as a baseline model” server 100 can designate the customer engagement model with the higher model effectiveness as a baseline model. For example, processor 110 in executing instructions 122 can designate one of customer engagement models 123-n with the highest effectiveness (e.g., greatest customer engagement with generated product offers, or the like) as the baseline model.

Continuing to block 630 “add and/or remove customer engagement models form the number of customer of engagement models” server 100 can add and/or remove ones of the customer engagement models 123-n. For example, processor 110 in executing instructions 122 can add and/or remove customer engagement models 123-n from the pool of customer engagement models. In some implementations, new models can be added as development models (e.g., the customer engagement models 123-n not designated as the baseline model) while development models that do not perform well (e.g., effectiveness below a cutoff value) can be removed from use.

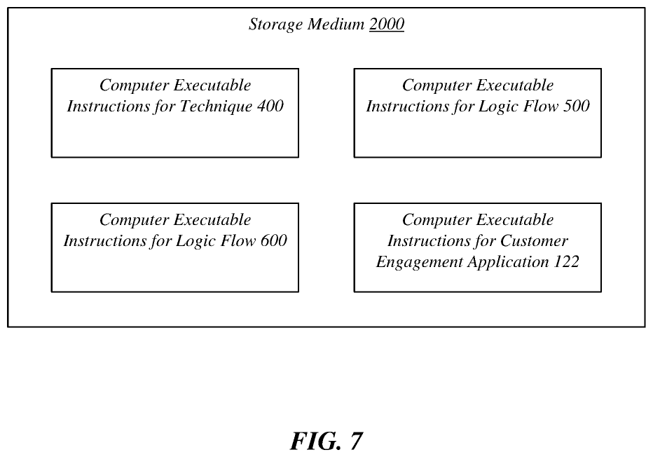

FIG. 7 illustrates an embodiment of a storage medium 2000. Storage medium 2000 may comprise any non-transitory computer-readable storage medium or machine-readable storage medium, such as an optical, magnetic or semiconductor storage medium. In various embodiments, storage medium 2000 may comprise an article of manufacture. In some embodiments, storage medium 2000 may store computer-executable instructions, such as computer-executable instructions to implement one or more of techniques, logic flows, or operations described herein, such as with respect to 400, 500, and/or 600 of FIGS. 4 to 6. The storage medium 2000 may further store computer-executable instructions for the customer engagement application 122. Examples of a computer-readable storage medium or machine-readable storage medium may include any tangible media capable of storing electronic data, including volatile memory or non-volatile memory, removable or non-removable memory, erasable or non-erasable memory, writeable or re-writeable memory, and so forth. Examples of computer-executable instructions may include any suitable type of code, such as source code, compiled code, interpreted code, executable code, static code, dynamic code, object-oriented code, visual code, and the like. The embodiments are not limited in this context.

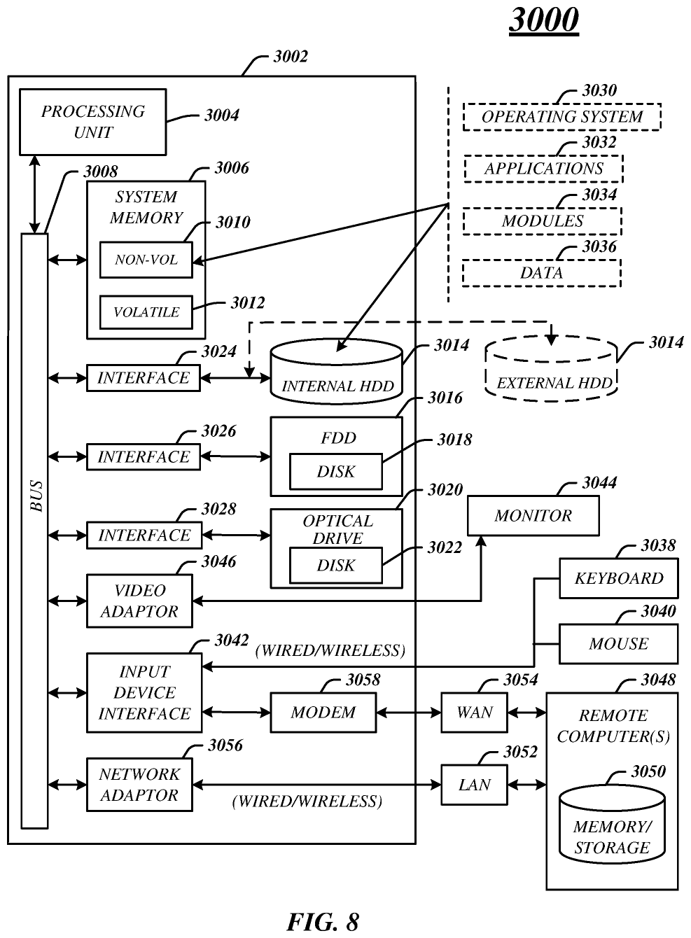

FIG. 8 illustrates an embodiment of an exemplary computing architecture 3000 that may be suitable for implementing various embodiments as previously described. In various embodiments, the computing architecture 3000 may comprise or be implemented as part of an electronic device. In some embodiments, the computing architecture 3000 may be representative, for example, of a computing device that implements one or more components of server 100. The embodiments are not limited in this context.

As used in this application, the terms “system” and “component” and “module” are intended to refer to a computer-related entity, either hardware, a combination of hardware and software, software, or software in execution, examples of which are provided by the exemplary computing architecture 3000. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 3000 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 3000.

As shown in this figure, the computing architecture 3000 comprises a processing unit 3004, a system memory 3006 and a system bus 3008. The processing unit 3004 can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core (2) Duo®, Itanium®, Pentium®, Xeon®, and XScale® processors; and similar processors. Dual microprocessors, multi-core processors, and other multi-processor architectures may also be employed as the processing unit 3004.

The system bus 3008 provides an interface for system components including, but not limited to, the system memory 3006 to the processing unit 3004. The system bus 3008 can be any of several types of bus structure that may further interconnect to a memory bus (with or without a memory controller), a peripheral bus, and a local bus using any of a variety of commercially available bus architectures. Interface adapters may connect to the system bus 3008 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The system memory 3006 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory (e.g., one or more flash arrays), polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in this figure, the system memory 3006 can include non-volatile memory 3010 and/or volatile memory 3012. A basic input/output system (BIOS) can be stored in the non-volatile memory 3010.

The computer 3002 may include various types of computer-readable storage media in the form of one or more lower speed memory units, including an internal (or external) hard disk drive (HDD) 3014, a magnetic floppy disk drive (FDD) 3016 to read from or write to a removable magnetic disk 3018, and an optical disk drive 3020 to read from or write to a removable optical disk 3022 (e.g., a CD-ROM or DVD). The HDD 3014, FDD 3016 and optical disk drive 3020 can be connected to the system bus 3008 by a HDD interface 3024, an FDD interface 3026 and an optical drive interface 3028, respectively. The HDD interface 3024 for external drive implementations can include at least one or both of Universal Serial Bus (USB) and IEEE interface technologies.

The drives and associated computer-readable media provide volatile and/or nonvolatile storage of data, data structures, computer-executable instructions, and so forth. For example, a number of program modules can be stored in the drives and memory units 3010, 3012, including an operating system 3030, one or more application programs 3032, other program modules 3034, and program data 3036. In one embodiment, the one or more application programs 3032, other program modules 3034, and program data 3036 can include, for example, the various applications and/or components of the wire-free charging system 100.

A user can enter commands and information into the computer 3002 through one or more wire/wireless input devices, for example, a keyboard 3038 and a pointing device, such as a mouse 3040. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processing unit 3004 through an input device interface 3042 that is coupled to the system bus 3008 but can be connected by other interfaces such as a parallel port, IEEE 994 serial port, a game port, a USB port, an IR interface, and so forth.

A monitor 3044 or other type of display device is also connected to the system bus 3008 via an interface, such as a video adaptor 3046. The monitor 3044 may be internal or external to the computer 3002. In addition to the monitor 3044, a computer typically includes other peripheral output devices, such as speakers, printers, and so forth.

The computer 3002 may operate in a networked environment using logical connections via wire and/or wireless communications to one or more remote computers, such as a remote computer 3048. The remote computer 3048 can be a workstation, a server computer, a router, a personal computer, portable computer, microprocessor-based entertainment appliance, a peer device or other common network node, and typically includes many or all of the elements described relative to the computer 3002, although, for purposes of brevity, only a memory/storage device 3050 is illustrated. The logical connections depicted include wire/wireless connectivity to a local area network (LAN) 3052 and/or larger networks, for example, a wide area network (WAN) 3054. Such LAN and WAN networking environments are commonplace in offices and companies, and facilitate enterprise-wide computer networks, such as intranets, all of which may connect to a global communications network, for example, the Internet.

When used in a LAN networking environment, the computer 3002 is connected to the LAN 3052 through a wire and/or wireless communication network interface or adaptor 3056. The adaptor 3056 can facilitate wire and/or wireless communications to the LAN 3052, which may also include a wireless access point disposed thereon for communicating with the wireless functionality of the adaptor 3056.

When used in a WAN networking environment, the computer 3002 can include a modem 3058, or is connected to a communications server on the WAN 3054, or has other means for establishing communications over the WAN 3054, such as by way of the Internet. The modem 3058, which can be internal or external and a wire and/or wireless device, connects to the system bus 3008 via the input device interface 3042. In a networked environment, program modules depicted relative to the computer 3002, or portions thereof, can be stored in the remote memory/storage device 3050. It will be appreciated that the network connections shown are exemplary and other means of establishing a communications link between the computers can be used.

The computer 3002 is operable to communicate with wire and wireless devices or entities using the IEEE 802 family of standards, such as wireless devices operatively disposed in wireless communication (e.g., IEEE 802.16 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11x (a, b, g, n, etc.) to provide secure, reliable, fast wireless connectivity. A Wi-Fi network can be used to connect computers to each other, to the Internet, and to wire networks (which use IEEE 802.3-related media and functions).

1. An apparatus, comprising:
a processor; and
a memory coupled to the processor, the memory comprising instructions that executed by the processor cause the processor to:
receive, at a server, a request to provide at least one product offer to a user;
determine a plurality of characteristics about the user;
determine the at least one product offer from a set of product offers indicated in a product offer database coupled to the server based on the plurality of characteristics about the user and a one of a plurality of customer engagement models, the one of the plurality of customer engagement models selected based on a usage threshold for each of the plurality of customer engagement models, wherein the usage threshold specifies how often each customer engagement model should be used respective to the other customer engagement models;
send, to a device associated with the user, an information element including an indication of the at least one product offer;
receive, at the server, a second request to provide at least one second product offer to a second user;
determine a plurality of characteristics about the second user;
determine the at least one second product offer based on the plurality of characteristics about the second user and a second one of the plurality of customer engagement models, the second one of the plurality of customer engagement models selected based on a usage threshold for each of the plurality of customer engagement models;
send, to a second device associated with the second user, an information element including an indication of the at least one second product offer;
determine an effectiveness of the one of the plurality of customer engagement models, the effectiveness to be determined based on customer click through or subsequent purchase data associated with presentation of the at least one product offer on the device and received at the server;
determine an effectiveness of the second one of the plurality of customer engagement models, the effectiveness to be determined based on customer click through or subsequent purchase data associated with presentation of the at least one second product offer on the second device;
determine that the effectiveness of the one of the plurality of customer engagement models is less than the effectiveness of the second one of the plurality of customer engagement models;
remove the one of the plurality of customer engagement models from the set of the plurality of customer engagement models based on the determination that the effectiveness of the one of the plurality of customer engagement models is less than the effectiveness of the second one of the plurality of customer engagement models; and
increase the usage threshold for the second one of the plurality of customer engagement models based on the determination that the effectiveness of the one of the plurality of customer engagement models is less than the effectiveness of the second one of the plurality of customer engagement models.

2-3. (canceled)

4. The apparatus of claim 1, the memory further comprising instructions that when executed by the processor cause the processor to:
decrease the usage threshold for the one of the plurality of customer engagement models based on the determination that the effectiveness of the one of the plurality of customer engagement models is less than the effectiveness of the second one of the plurality of customer engagement models; and
increase the usage threshold for the second one of the plurality of customer engagement models based on the determination that the effectiveness of the one of the plurality of customer engagement models is less than the effectiveness of the second one of the plurality of customer engagement models.

5. (canceled)

6. The apparatus of claim 1, the memory further comprising instructions that when executed by the processor cause the processor to add a new customer engagement model to the set of the plurality of customer engagement models.

7. The apparatus of claim 1, the memory further comprising instructions that when executed by the processor cause the processor to:
determine a click-through rate for the at least one product offer; and
determine the effectiveness of the one of the plurality of customer engagement models based in part on the click-through rate.

8. The apparatus of claim 1, the memory further comprising instructions that when executed by the processor cause the processor to:
determine a customer engagement score for the at least one product offer; and
determine the effectiveness of the one of the plurality of customer engagement models based in part on the customer engagement score.

9. The apparatus of claim 1, wherein the one of the plurality of customer engagement models is a baseline model and wherein the other ones of the plurality of customer engagement models are development models.

10. The apparatus of claim 9, wherein the usage threshold for the baseline model is greater than or equal to 90 percent and combined the usage thresholds for the development models is less than or equal to 10 percent.

11. The apparatus of claim 1, wherein the at least one product offer is the same as the at least one second product offer.

12. At least one machine-readable storage medium comprising instructions that when executed by a processor at a computing platform, cause the processor to:
receive a request to provide at least one product offer to a user;
determine a plurality of characteristics about the user;
determine the at least one product offer from a set of product offers indicated in a product offer database based on the plurality of characteristics about the user and a one of a plurality of customer engagement models, the one of the plurality of customer engagement models selected based on a usage threshold for each of the plurality of customer engagement models, wherein the usage threshold specifies how often each customer engagement model should be used respective to the other customer engagement models;
send, to a device associated with the user, an information element including an indication of the at least one product offer;
receive a second request to provide at least one second product offer to a second user;
determine a plurality of characteristics about the second user;
determine the at least one second product offer from the set of product offers indicated in the product offer database based on the plurality of characteristics about the second user and a second one of the plurality of customer engagement models, the second one of the plurality of customer engagement models selected based on a usage threshold for each of the plurality of customer engagement models;
send, to a second device associated with the second user, an information element including an indication of the at least one second product offer;
determine an effectiveness of the one of the plurality of customer engagement models, the effectiveness to be determined based on customer click through or subsequent purchase data associated with presentation of the at least one product offer on the device;
determine an effectiveness of the second one of the plurality of customer engagement models, the effectiveness to be determined based on customer click through or subsequent purchase data associated with the presentation of the at least one second product offer on the second device;
determine that the effectiveness of the one of the plurality of customer engagement models is less than the effectiveness of the second one of the plurality of customer engagement models;
remove the one of the plurality of customer engagement models from the set of the plurality of customer engagement models based on the determination that the effectiveness of the one of the plurality of customer engagement models is less than the effectiveness of the second one of the plurality of customer engagement models; and
increase the usage threshold for the second one of the plurality of customer engagement models based on the determination that the effectiveness of the one of the plurality of customer engagement models is less than the effectiveness of the second one of the plurality of customer engagement models.

13. (canceled)

14. The at least one machine-readable storage medium of claim 12, comprising instructions that further cause the processor to add a new customer engagement model to the set of the plurality of customer engagement models.

15. The at least one machine-readable storage medium of claim 12, comprising instructions that further cause the processor to:
determine a click-through rate for the at least one product offer; and
determine the effectiveness of the one of the plurality of customer engagement models based in part on the click-through rate.

16. The at least one machine-readable storage medium of claim 12, wherein the one of the plurality of customer engagement models is a baseline model and wherein the other ones of the plurality of customer engagement models are development models and wherein the usage threshold for the baseline model is greater than or equal to 90 percent and combined the usage thresholds for the development models is less than or equal to 10 percent.

17. A method comprising
receiving at a server, from a first device, a request to provide at least one product offer to a user;
determining a plurality of characteristics about the user;
determining the at least one product offer from a set of product offers indicated in a database coupled to the server based on the plurality of characteristics about the user and a one of a plurality of customer engagement models, the one of the plurality of customer engagement models selected based on a usage threshold for each of the plurality of customer engagement models, wherein the usage threshold specifies how often each customer engagement model should be used respective to the other customer engagement models;
sending, to the first device, an information element including an indication of the at least one product offer;
receiving at the server, from a second device, a second request to provide at least one second product offer to a second user;
determining a plurality of characteristics about the second user;
determining the at least one second product offer based on the plurality of characteristics about the second user and a second one of the plurality of customer engagement models, the second one of the plurality of customer engagement models selected based on a usage threshold for each of the plurality of customer engagement models;
sending, to the second device, an information element including an indication of the at least one second product offer
determining an effectiveness of the one of the plurality of customer engagement models, the effectiveness to be determined based on customer click through or subsequent purchase data associated with presentation of the at least one product offer on the device;
determining an effectiveness of the second one of the plurality of customer engagement models, the effectiveness to be determined based on customer click through or subsequent purchase data associated with presentation of the at least one second product offer on the second device;
determining that the effectiveness of the one of the plurality of customer engagement models is less than the effectiveness of the second one of the plurality of customer engagement models;
removing the one of the plurality of customer engagement models from the set of the plurality of customer engagement models based on the determination that the effectiveness of the one of the plurality of customer engagement models is less than the effectiveness of the second one of the plurality of customer engagement models; and
increasing the usage threshold for the second one of the plurality of customer engagement models based on the determination that the effectiveness of the one of the plurality of customer engagement models is less than the effectiveness of the second one of the plurality of customer engagement models.

18. (canceled)

19. The method of claim 17, comprising:
determining a click-through rate for the at least one product offer; and
determining the effectiveness of the one of the plurality of customer engagement models based in part on the click-through rate.

20. The method of claim 17, wherein the one of the plurality of customer engagement models is a baseline model and wherein the other ones of the plurality of customer engagement models are development models and wherein the usage threshold for the baseline model is greater than or equal to 90 percent and combined the usage thresholds for the development models is less than or equal to 10 percent.
